(19) United States
(12) Patent Application Publication
(10) Pub. No.: US 2019/0327949 A1
(43) Pub. Date: Oct. 31, 2019

(54) Portable Storage Unit

(71) Applicant: William Paul Jackson, Midvale, UT (US)

(72) Inventor: William Paul Jackson, Midvale, UT (US)

(21) Appl. No.: 16/297,514

(22) Filed: Mar. 8, 2019

Related U.S. Application Data
(60) Provisional application No. 62/614,822, filed on Jan. 8, 2018.

(51) Int. Cl. A01K 97/22; A01K 97/10; A01K 97/06

(52) U.S. Cl. CPC A01K 97/22; A01K 97/06; A01K 97/10

(57) ABSTRACT

A portable storage device with seating capabilities includes of a hollow enclosure, a planar top panel, a planar bottom panel, a first opening, a second opening, at least one pull-out drawer, and a sliding mechanism. The planar top panel and the planar bottom panel are connected at opposite ends of the hollow enclosure. Both the first opening and the second opening traverse into a structural body of the hollow enclosure. Thus, an interior of the hollow enclosure can be accessed through the first opening or the second opening. Preferably, the at least one pull-out drawer is integrated into the first opening through the sliding mechanism. As a result, small items can be organized in the at least one pull-out drawer. The planar top panel, which can be sleeved by a padded cover, is used for seating purposes when the hollow enclosure is in an upright position.

The current application claims a priority to the U.S. Provisional Patent application Ser. No. 62/614,822 filed on Jan. 8, 2018.

### FIELD OF THE INVENTION

The present invention relates generally to furniture and sports equipment. More specifically, the present invention relates to padded seats with multicompartmental storage spaces.

### BACKGROUND OF THE INVENTION

Outdoor sports are popular activities enjoyed by thousands of people across the world. Fishing, for example, is a popular outdoor activity enjoyed by many people. In general, fishing requires few devices in order for people to enjoy it. A fishing rod, a few fishing baits, and a container to hold the captured fish is often enough to have a good time fishing. However, due to the long period of time involved in fishing, a seat or similar device is often needed so the user can have somewhere to seat while fishing. While a place to seat can be found when fishing on a boat or similar vessel, there is not always a place to seat when fishing on a river or lake. Some people have modified buckets or similar containers, so people can sit on them while fishing. However, these modifications are not very practical when a fish has been captured and the user needs to store the fish away. Another solution to this problem is to bring a portable chair. But, carrying extra devices can be uncomfortable to carry around, especially after a long day of fishing. Furthermore, it is always desired to have storage space to carry the various accessories which are often used by the more experienced users. There are currently available storage devices which provide a number of compartments for users to store away various small devices. However, these devices do not provide a space to store away captured fish and are often not suitable for a user to comfortably sit on. So, an outdoor sports device which provides a place for a user to sit on, provides a space where a bucket or similar device can be stored and easily accessed, and further provides a number of storage spaces where small devices can be placed is beneficial and necessary.

An objective of the present invention is to provide a padded seat with storage which provides a sports/fishing bucket which doubles as a padded seat. Another objective of the present invention is to provide a padded seat with storage which provides a large storage space where a device such as bucket can be placed. Another objective of the present invention is to provide a padded seat with storage which further provides a number of small storage spaces where small items can be placed. Another objective of the present invention is to provide a padded seat with storage which provides a place to attach a fishing rod holder. Another objective of the present invention is to provide a padded seat with storage which further provides a number of place where to hold a liquid container. Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a perspective view of the present invention.

FIG. 2 is a bottom perspective view of the present invention.

FIG. 3 is a side view of the present invention.

FIG. 4 is another side view of the present invention.

FIG. 5 is a top view of the present invention.

FIG. 6 is an exploded perspective view of the present invention.

FIG. 7 is another exploded perspective view of the present invention, wherein the second opening is illustrated.

FIG. 8 is another side view of the present invention, wherein the holding pouch and the padded cover are illustrated.

### DETAIL DESCRIPTIONS OF THE INVENTION

All illustrations of the drawings are for the purpose of describing selected versions of the present invention and are not intended to limit the scope of the present invention.

The present invention introduces an apparatus that can be used for storage purposes and simultaneously be used for seating purposes. Thus, when engaging in outdoor activities such as fishing or camping, the need to carry both a seat and a storage compartment separately is eliminated by utilizing the present invention.

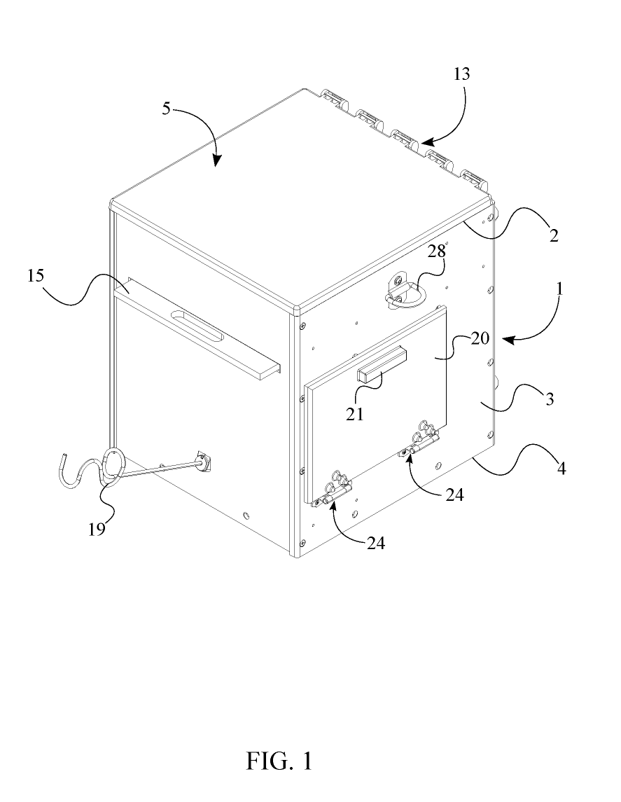

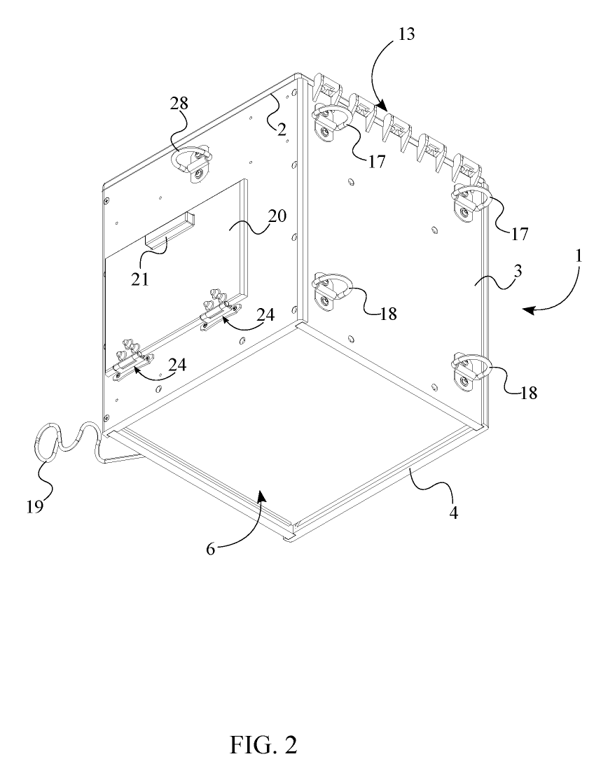

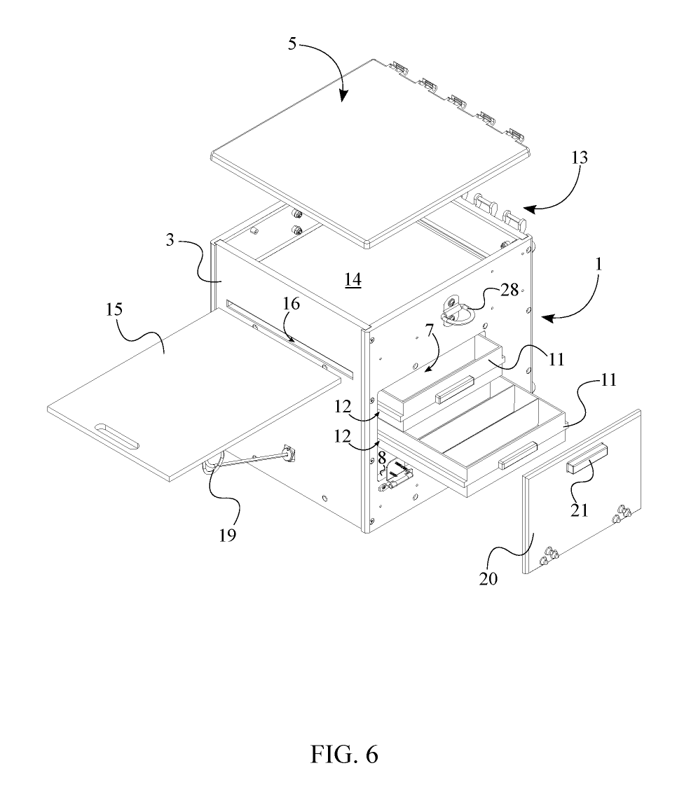

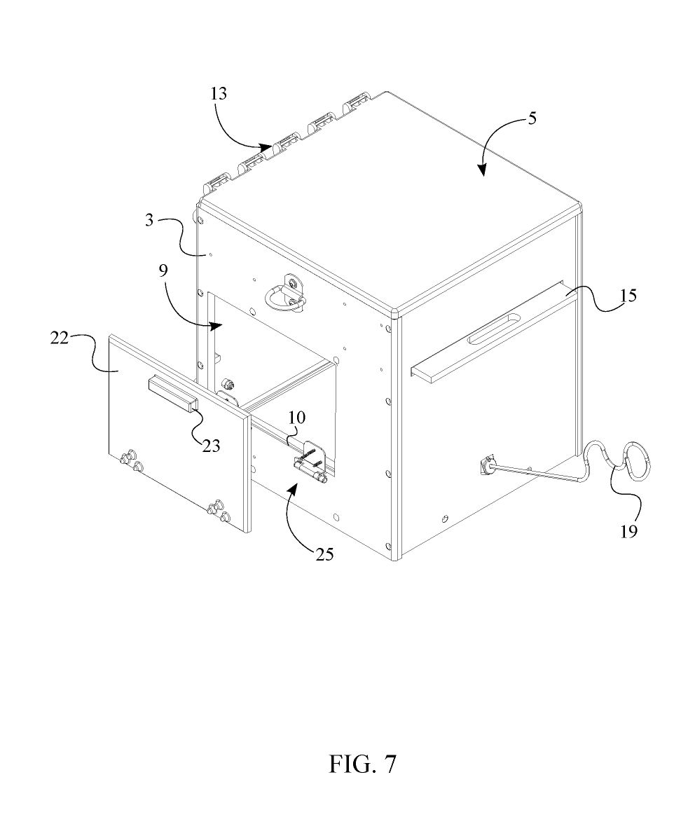

As seen in FIG. 1, FIG. 2, FIG. 6, and FIG. 7, to fulfill the intended functionalities, the present invention comprises a hollow enclosure 1, a planar top panel 5, a planar bottom panel 6, a first opening 7, a second opening 9, at least one pull-out drawer 11, and a sliding mechanism 12. The hollow enclosure 1, which can vary in size and shape in different embodiments of the present invention, provides the surface area required for storage purposes. The planar top panel 5 and the planar bottom panel 6 can vary according to the size and shape of the hollow enclosure 1. The planar bottom panel 6, which is connected to the hollow enclosure 1, ensures that the hollow enclosure 1 can remain in an upright position. On the other hand, the planar top panel 5 can be used for seating purposes when the hollow enclosure 1 is in an upright position. To hold the weight of a user, the planar top panel 5, the hollow enclosure 1, and the planar bottom panel 6 are manufactured from a sturdy yet lightweight material which can be, but is not limited to, wood. The first opening 7 and the second opening 9 are used to access an interior of the hollow enclosure 1 such that items can be stored within the hollow enclosure 1. The at least one pull-out drawer 11 is used along with the sliding mechanism 12 to store small items in an organized manner.

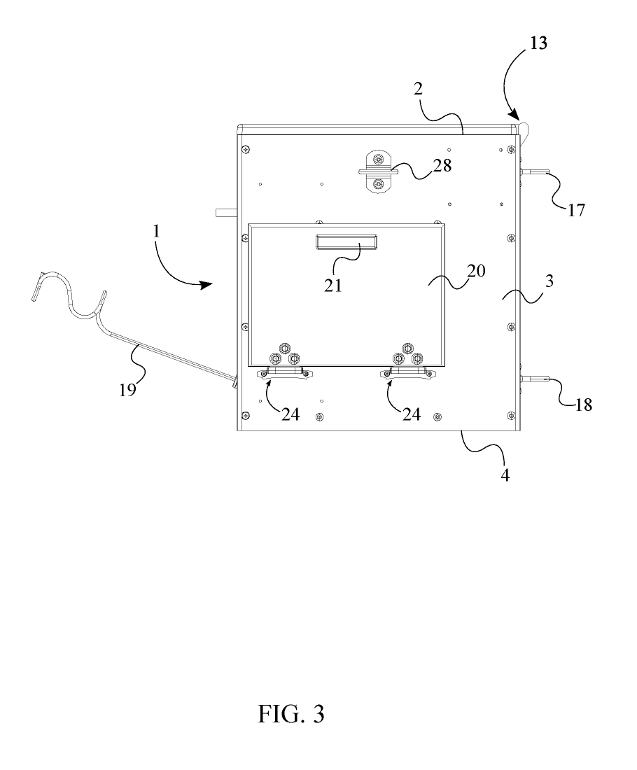

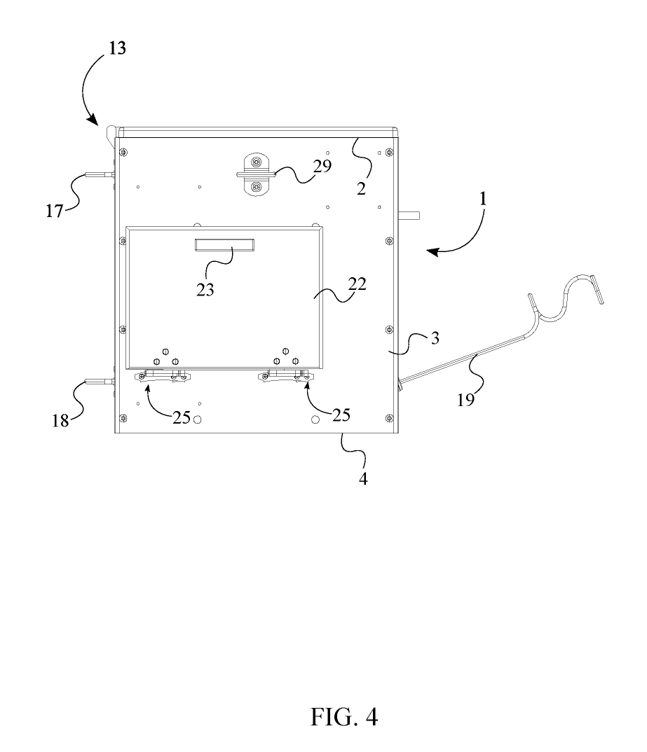

As seen in FIGS. 1-4. the hollow enclosure 1 comprises a first end 2, a structural body 3, and a second end 4, wherein the structural body 3 extends from the first end 2 to the second end 4. In the preferred embodiment of the present invention, the structural body 3 is rectangular in shape such that the overall shape of the present invention is also rectangular. However, in other embodiments of the present invention, the shape of the structural body 3 can vary. For the present invention to have a base section, the hollow enclosure 1 is terminally connected to the planar bottom panel 6 at the second end 4. On the other hand, the planar top panel 5 is terminally connected to the hollow enclosure 1 at the first end 2 opposite the planar bottom panel 6 along the structural body 3. Thus, the structural body 3 is positioned in between the planar top panel 5 and the planar bottom panel 6. The first opening 7, which can vary in size and shape in different embodiments, traverses into the structural body 3 in between the first end 2 and the second end 4. In the preferred embodiment, the at least one pull-out drawer 11 is slidably positioned into the first opening 7 through the sliding mechanism 12, wherein the sliding mechanism 12 can vary in different embodiments of the present invention. In the preferred embodiment, the sliding mechanism 12 comprises a pair of rails, and a pair of rail-receiving slots. Each of the pair of rails is laterally connected to the at least one pull-out drawer 11. The pair of rail-receiving slots is integrated along an internal surface of the hollow enclosure 1 so that the at least one pull-out drawer 11 can be slidably positioned into the pair of rail-receiving slots. Similar to the first opening 7, the second opening 9 also traverses into the structural body 3 in between the first end 2 and the second end 4. Preferably, the second opening 9 will be sufficiently sized to receive a bucket or other comparable object.

As seen in FIG. 6, to optimize the storage area, the present invention further comprises a pivoting mechanism 13 and an intermediary panel 14. The planar top panel 5 is pivotably connected to the first end 2 through the pivoting mechanism 13 so that the user can access the interior of the hollow enclosure 1 at the first end 2. In order to provide an additional storage compartment that can be accessed at the first end 2, the intermediary panel 14 is positioned within the structural body 3 adjacent the first end 2. A distance from the first end 2 to the intermediary panel 14 can vary in different embodiments of the present invention. Thus, the overall size of the additional storage compartment created in between the intermediary panel 14 and the planar top panel 5 can vary according to the position of the intermediary panel 14. When the planar top panel 5 is in a closed configuration, the planar top panel 5, the intermediary panel 14, and the planar bottom panel 6 will be positioned adjacent to each other. When the planar top panel 5 is in an open configuration, the user can store items on the intermediary panel 14 by accessing the hollow enclosure 1 at the first end 2.

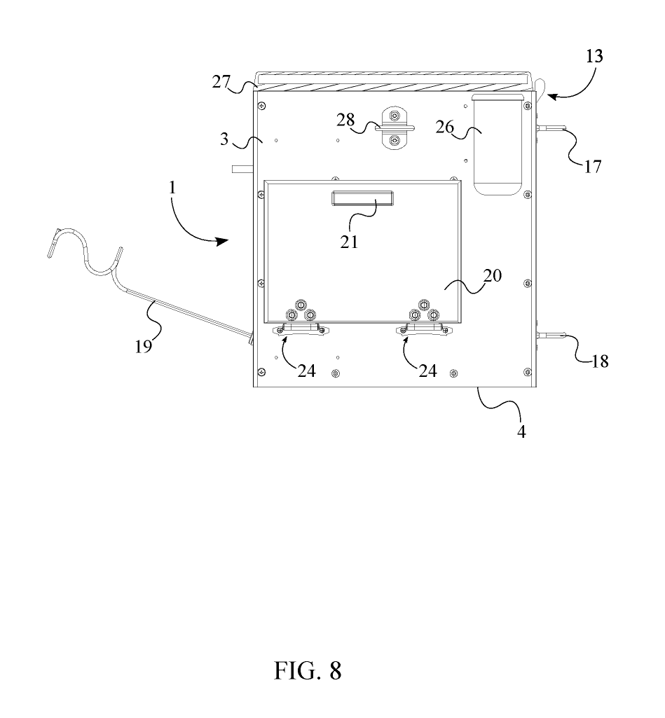

As further illustrated in FIG. 6, the present invention further comprises a pull-out panel 15 and a panel-receiving slot 16. The pull-out panel 15 is intended to be used as a tray when engaging in activities such as fishing. The pull-out panel 15 is slidably positioned into the panel-receiving slot 16 which traverses into the structural body 3 adjacent the first end 2. Thus, when the user is seated on the planar top panel 5 which is connected at the first end 2, the pull-out panel 15 can be easily accessed. As shown in FIG. 8, to provide comfort to the user when seated on the planar top panel 5, the present invention further comprises a padded cover 27 that sleeves the planar top panel 5. The padded cover 27 can be either fixed or removably attached to the planar top panel 5 in different embodiments of the present invention. Moreover, the padded cover 27 can be made of material that can be, but is not limited to, foam or sponge.

As shown in FIG. 2, for the user to carry the present invention from one location to another, the present invention further comprises a first pair of strap receivers 17 and a second pair of strap receivers 18. The first pair of strap receivers 17 is externally connected to the hollow enclosure 1 adjacent the first end 2. On the other hand, the second pair of strap receivers 18 is externally connected to the hollow enclosure 1 adjacent the second end 4 opposite the first pair of strap receivers 17 along the structural body 3. Therefore, when at least one strap is inserted through the first pair of strap receivers 17 and the second pair of strap receivers 18, the user can carry the present invention as a backpack.

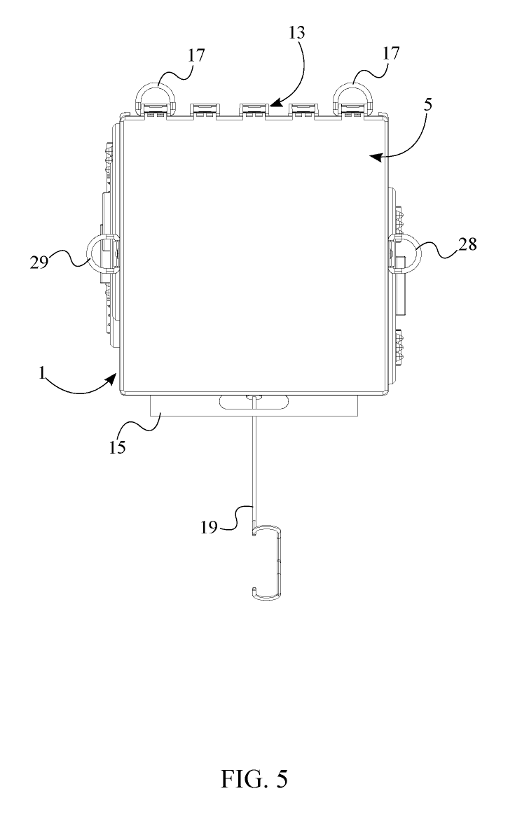

As seen in FIG. 5, the present invention further comprises a first strap-receiving hook 28 and a second strap-receiving hook 29 that allows the user to carry the present invention as a shoulder bag. The first strap-receiving hook 28 is externally connected to the hollow enclosure 1 adjacent the second end 4. On the other hand, the second strap-receiving hook 29 is externally connected to the hollow enclosure 1 opposite the first strap-receiving hook 28 across the structural body 3. Therefore, by inserting a carrying strap through both the first strap-receiving hook 28 and the second strap-receiving hook 29, the user can maintain control when carrying the present invention from one location to another.

As illustrated in FIGS. 6-8, to secure the content stored within the hollow enclosure 1, the present invention further comprises a first cover 20, a second cover 22, a first hinging mechanism 24, and a second hinging mechanism 25. The first cover 20 and the second cover 22 are used to enclose the first opening 7 and the second opening 9 respectively. The first hinging mechanism 24 and the second hinging mechanism 25 are used to control the position of the first cover 20 and the second cover 22. To do so, the first cover 20 is hingedly connected along a first lateral edge 8 of the first opening 7 through the first hinging mechanism 24. On the other hand, the second cover 22 is hingedly connected along a second lateral edge 10 of the second opening 9 through the second hinging mechanism 25.

As further illustrated in FIG. 6 and FIG. 7, for user convenience, the present invention further comprises a first gripping protrusion 21 and a second gripping protrusion 23. The first gripping protrusion 21 is externally mounted onto the first cover 20. Therefore, the user can control the first cover 20 by grasping the first gripping protrusion 21. Similar to the first gripping protrusion 21, the second gripping protrusion 23 is externally mounted onto the second cover 22. Thus, the user can control the position of the second cover 22 by grasping the second gripping protrusion 23.

As shown in FIG. 8, in another embodiment, the present invention further comprises a holding pouch 26 which is preferably externally connected to the hollow enclosure 1. The holding pouch 26 can be used to hold items that can be, but is not limited to, a water bottle. As mentioned before, the present invention is preferably used when fishing. To accommodate the equipment used during fishing, the present invention further comprises at least one fishing rod holder 19 that is externally connected to the hollow enclosure 1 adjacent the second end 4.

Although the invention has been explained in relation to its preferred embodiment, it is to be understood that many other possible modifications and variations can be made without departing from the spirit and scope of the invention as hereinafter claimed.

What is claimed is:

1. A portable storage unit comprises:
a hollow enclosure;
a planar top panel;
a planar bottom panel;
a first opening;
a second opening;
at least one pull-out drawer;
a sliding mechanism;
the hollow enclosure comprises a first end, a structural body, and a second end;
the structural body extending from the first end to the second end;
the hollow enclosure being terminally connected to the planar bottom panel at the second end;
the planar top panel being terminally connected to the hollow enclosure at the first end opposite the planar bottom panel along the structural body;
the first opening traversing into the structural body in between the first end and the second end;
the second opening traversing into the structural body in between the first end and the second end; and
the at least one pull-out drawer being slidably positioned into the first opening through the sliding mechanism.

2. The portable storage unit as claimed in claim 1 further comprises:
a pivoting mechanism;
an intermediary panel;
the planar top panel being pivotably connected to the first end through the pivoting mechanism;
the intermediary panel being positioned within the structural body adjacent the first end; and
the planar top panel, the intermediary panel, and the planar bottom panel being positioned in parallel to each other, wherein the planar top panel is in a closed configuration.

3. The portable storage unit as claimed in claim 1 further comprises:
a pull-out panel;
a panel-receiving slot;
the panel-receiving slot traversing into the structural body adjacent the first end; and
the pull-out panel being slidably positioned into the panel-receiving slot.

4. The portable storage unit as claimed in claim 1 further comprises:
a first pair of strap receivers;
a second pair of strap receivers;
the first pair of strap receivers being externally connected to the hollow enclosure adjacent the first end; and
the second pair of strap receivers being externally connected to the hollow enclosure adjacent the second end opposite the first pair of strap receivers along the structural body.

5. The portable storage unit as claimed in claim 1 further comprises:
at least one fishing rod holder; and
the at least one fishing rod holder being externally connected to the hollow enclosure adjacent the second end.

6. The portable storage unit as claimed in claim 1 further comprises:
a first cover;
a second cover;
a first hinging mechanism;
a second hinging mechanism;
the first cover being hingedly connected along a first lateral edge of the first opening through the first hinging mechanism; and
the second cover being hingedly connected along a second lateral edge of the second opening through the second hinging mechanism.

7. The portable storage unit as claimed in claim 6 further comprises:
a first gripping protrusion; and
the first gripping protrusion being externally mounted onto the first cover.

8. The portable storage unit as claimed in claim 6 further comprises:
a second gripping protrusion; and
the second gripping protrusion being externally mounted onto the second cover.

9. The portable storage unit as claimed in claim 1 further comprises:
a holding pouch; and
the holding pouch being externally connected to the hollow enclosure.

10. The portable storage unit as claimed in claim 1 further comprises:
a padded cover; and
the planar top panel being sleeved by the padded cover.

11. The portable storage unit as claimed in claim 1 further comprises:
a first strap-receiving hook;
a second strap-receiving hook;
the first strap-receiving hook being externally connected to the hollow enclosure adjacent the second end; and
the second strap-receiving hook being externally connected to the hollow enclosure opposite the first strap-receiving hook across the structural body.

12. The portable storage unit as claimed in claim 1, wherein the hollow structural body is a rectangular in shape.
